(19) United States
(12) Patent Application Publication
(10) Pub. No.: US 2006/0017268 A1
(43) Pub. Date: Jan. 26, 2006

(54) Set for masking safety airbag with reinforcing members and corresponding methods for making same

(76) Inventor: Marc Bondoerffer, Meru Cedex (FR)

Correspondence Address: YOUNG & THOMPSON, 745 SOUTH 23RD STREET, 2ND FLOOR, ARLINGTON, VA, 22202, US

(21) Appl. No.: 10/521,443

(22) PCT Filed: Jul. 17, 2003
(86) PCT No.: PCT/FR03/02268

§ 371 Date: Jul. 27, 2005

(30) Foreign Application Priority Data
Jul. 17, 2002 (FR) 02/09070

(51) Int. Cl. B60R 21/16

(52) U.S. Cl. 280/732

(57) ABSTRACT

This assembly (1) for a motor vehicle includes outer trim (4) presenting a line (7) of weakness which defines a flap (9) covering an air-bag, and a peripheral region (10) surrounding the flap, a first reinforcing member (12) for reinforcing the peripheral region (10), a second reinforcing member (13) for reinforcing the flap, and a hinge (14) connecting the first and second reinforcing members. The second reinforcing member (13) and the hinge (14) are made by molding a plastics material, and the hinge (14) is overmolded onto the first reinforcing member (12).

The present invention relates to an assembly for masking an air-bag for a motor vehicle, the assembly being of the type comprising:

outer trim presenting a line of weakness which defines:
a flap overlying the air-bag; and
a peripheral region surrounding the flap and serving, after the flap has moved, to define an opening for passing the air-bag during its deployment;

a first reinforcing member for reinforcing the peripheral region, the first reinforcing member comprising at least one wall for guiding the air-bag upstream from the opening and during deployment thereof;

a second reinforcing member for reinforcing the flap; and

a hinge connecting together the first reinforcing member and the second reinforcing member so as to allow the flap to tilt and so as to retain it after the masking assembly has been ruptured along the line of weakness.

The invention applies in particular to the dashboard of a motor vehicle masking an air-bag for protecting a passenger of a motor vehicle.

In general, in such a dashboard, the hinge is formed by a net of rigid wires to which the first and second reinforcing members are secured.

When the air-bag deploys, it strikes the second reinforcing member and causes the flap to be separated from the peripheral region of the dashboard along the line of weakness. The hinge serves firstly to allow the flap to pivot to as to let the air-bag pass through, and secondly serves to retain the flap so that it does not injure an occupant of the vehicle.

In known dashboards, it has been found that the net constituting the hinge can tear under the forces induced by the air-bag deploying. That leads to risks of injury for the occupants of the motor vehicle, and in particular for the passenger situated facing the air-bag.

An object of the invention is to solve the problem by providing an assembly of the above-specified type which serves to limit the risk of the hinge rupturing during deployment of the air-bag, and which is simple to make, and therefore inexpensive.

To this end, the invention provides a masking assembly of the above-specified type, characterized in that the second reinforcing member and the hinge are made by molding a plastics material, and in that the hinge is overmolded on the first reinforcing member.

In particular embodiments, the assembly may comprise one or more of the following characteristics, taken in isolation or in any technically feasible combination:

the plastics material of the second reinforcing member and of the hinge possesses elongation prior to rupture of more than 500%;

the first reinforcing member includes portions in relief for connecting the hinge;

the hinge includes a retaining lip surrounding an edge of the first reinforcing member;

the guide wall(s) extend(s) over at least two sides of the deployment direction of the air-bag so as to form a guide channel;

the guide channel extends over substantially the entire perimeter of the through opening for the air-bag;

the hinge includes at least one fold;

it constitutes at least a dashboard for a motor vehicle.

The invention also provides a method of making an assembly as defined above, the method being characterized in that it includes a step of overmolding a plastics material onto the first reinforcing member to form the hinge and the second reinforcing member, and to connect them to the first reinforcing member.

In a variant, the method includes a step of fastening the first reinforcing member and the second reinforcing member to the trim that has previously been prepared.

The invention will be better understood on reading the following description given purely by way of example and made with reference to the accompanying drawings, in which:

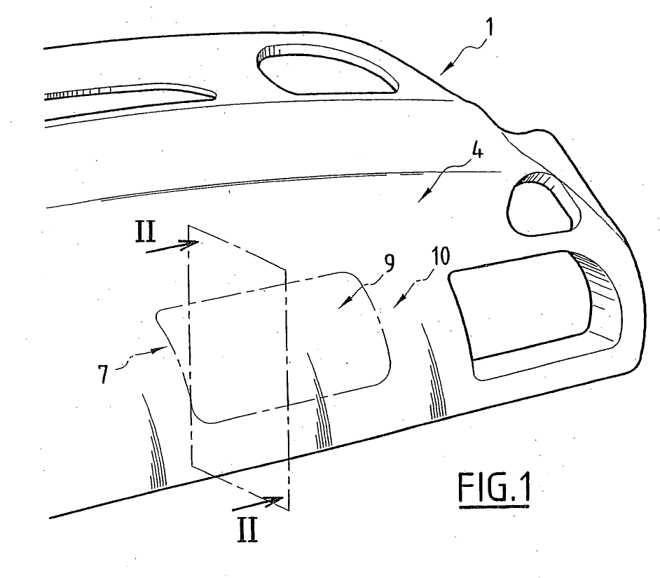

FIG. 1 is a diagrammatic, fragmentary perspective view of a dashboard of the invention; and

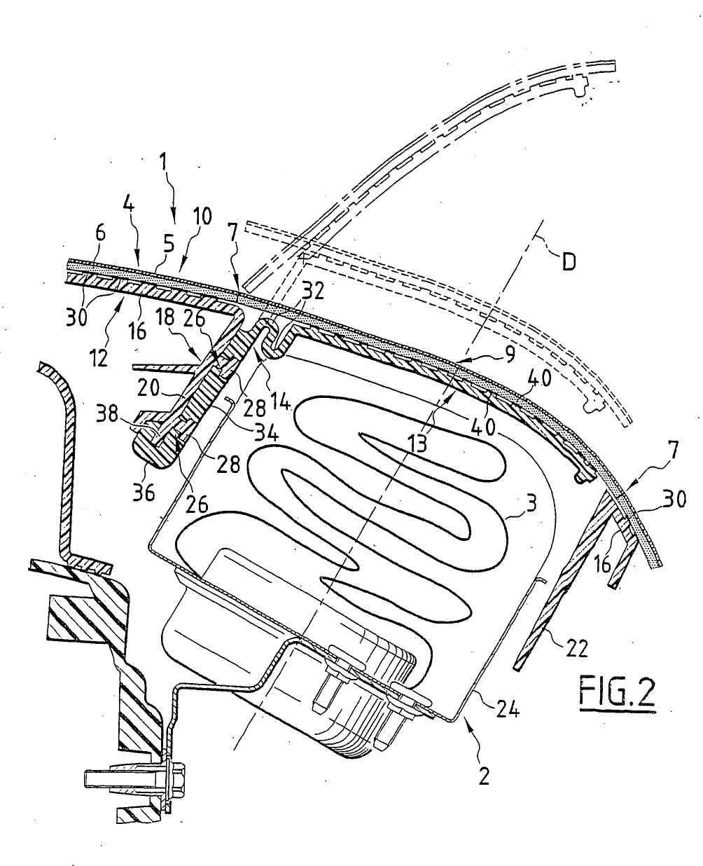

FIG. 2 is a diagrammatic fragmentary section view on plane II-II of FIG. 1.

Below, the directions are the usual directions for a motor vehicle. In particular the terms “front”, “rear”, “right”, and “left” should be understood relative to the position of a driver and to the forward direction of the vehicle.

FIG. 1 shows the right side portion of a dashboard 1 for a motor vehicle, which dashboard masks a system 2 having an air-bag 3 that can be seen in FIG. 2.

The system 2 is of conventional structure and is not described in detail below.

The dashboard 1 includes outer trim 4, itself comprising:

an outer skin 5, e.g. made of thermoplastic polyvinyl chloride (PVC), of thermoplastic polyolefin (TPO), or of thermoplastic polyurethane (TPU), or of any other thermoplastic material enabling a flexible skin to be made; and

an inner layer 6 covered by the skin 5 and made, for example, of fiber-filled polypropylene so as to impart structural stiffness to the trim 4.

A line 7 of weakness is formed in the trim 4 and defines a flap 9 covering the air-bag system 2 and a peripheral region 10 surrounding the flap 9.

In plan view, the flap 9 is substantially in the form of a rectangle having rounded corners.

In conventional manner, and as described below, when the air-bag 3 deploys in a direction D (FIG. 2), it moves the flap 9 away from the peripheral region 10. The peripheral region 10 then forms a frame surrounding a through passage where the flap 9 used to be for deployment of the air-bag.

The line 7 of weakness is made in conventional manner, e.g. by means of a laser beam.

By way of example, the line 7 is constituted by a succession of spaced-apart cutouts passing through the inner layer 6 and made from the inside face of the trim 4 so as not to be visible from outside the dashboard 1.

The line 7 of weakness extends all around the periphery of the flap 9.

The dashboard 1 has a structure 12 for reinforcing the peripheral region 10, a panel 13 for reinforcing the flap 9, and a hinge 14 connecting the reinforcing panel 13 to the reinforcing structure 12.

The reinforcing structure 12 comprises in particular a rounded web 16 which fits substantially snugly to the shape of the peripheral region 10 in the vicinity of the line 7 of weakness, and a channel 18 for guiding the air-bag while it is deploying.

The channel 18 extends the web 16 inwards from the dashboard 1, i.e. downwards and forwards in FIG. 2.

By way of example, when seen from above, the channel 18 presents a quadrangular section, thus possessing four side walls that extend substantially around the entire perimeter of the opening that will be formed in the dashboard 1 when the air-bag 3 deploys. Only the front wall 20 and the rear wall 22 of the channel 18 can be seen in FIG. 2. These walls 20 and 22 are situated on opposite sides of the direction D.

The housing 24 of the air-bag system 2 may be mounted on the channel 18, e.g. by engaging hooks of the housing 24 in openings formed in the side walls of the channel 18.

The front wall 20 of the channel 18 possesses portions in relief 26 for connecting the hinge 14, which portions are in the form of studs provided with enlarged heads 28. These studs 26 project from the wall 20 towards the inside of the channel 18.

The reinforcing structure 12 is made as a single piece of plastics material, e.g. by injection molding. By way of example, the plastics material may be fiberglass-filled polypropylene.

The reinforcing structure 12 is secured to the inside face of the layer 6 of the trim 4, in the peripheral region 10. This is achieved, for example, by vibration welding along ribs 30 that are provided on the outside face of the web 16 of the reinforcing structure 12.

The reinforcing panel 13 is of a rounded shape that corresponds substantially to that of the flap 9 and its dimensions are slightly smaller than those of the flap 9. The panel 13 is extended at its front edge (to the left in FIG. 2) by the hinge 14.

In succession, starting from the panel 13, the hinge 14 comprises two oppositely-directed folds 32, a connection wall 34 in which the studs 26 are embedded, and finally a lip 36 surrounding the bottom edge 38 of the front wall 20 of the channel 18. The reinforcing panel 13 and the hinge 14 are made by molding a plastics material, for example, it may be a styrene/ethylene/butylene/styrene (SEBS) block copolymer.

The plastics material is molded onto the front wall 20 of the channel 18 so as to connect the hinge 14 to the reinforcing structure 12.

The reinforcing panel 13 has been welded to the inside face of the flap 9, e.g. along ribs 40 provided on the outside face of the panel 13, using a vibration-welding technique.

To make the dashboard 1, the reinforcing structure 12 is molded and then the hinge 14 and the reinforcing panel 13 are molded onto the reinforcing structure 12. At the end of this overmolding operation, the studs 26 are embedded in the hinge 14 and the lip 36 surrounds the edge 38. The hinge 14, and thus the reinforcing panel 13, are firmly connected to the reinforcing structure 12 by the studs 26 and the lip 36.

Thereafter, the web 16 is welded to the reinforcing structure 12 and the reinforcing panel 13 is welded onto the outer trim 4 which has been made beforehand.

When the air-bag 3 deploys along the deployment direction D, it strikes the reinforcing panel 13 which pushes the flap 9 outwards from the dashboard 1, i.e. rearwards and upwards.

The dashboard 2 then splits along the line 7 of weakness and allows the flap 9 to separate from the peripheral region 10.

With the air-bag 3 continuing to push against the flap 9, the folds 32 of the hinge 14 unfold so as to allow the flap 9 to move away from the peripheral region 9 as shown in dashed lines in FIG. 2.

Thereafter, still under drive from the air-bag 3, the flap 9 pivots relative to the peripheral region 10 about the hinge 14 as shown in chain-dotted lines in FIG. 2.

The air-bag 3 can then deploy through the opening that has been released in this way by the flap 9 in the dashboard 1.

As the air-bag 3 deploys, the channel 18 whose side walls are disposed on four sides around the direction D serve to guide the air-bag 3 upstream from the opening in the dashboard 1. It should be observed that the front wall 20 guides the air-bag 3 via the wall 34 covering said front wall.

During the displacement of the flap 9, the studs 26 and the covering lip 36 ensure that the flap 9 is well retained relative to the peripheral region 10 of the dashboard, thereby compensating the fact that the material used for making the reinforcing structure 12 and the reinforcing panel 13 do not interact.

In addition, using a highly deformable flexible plastics material to constitute the hinge 14 serves to limit the risk of it tearing. The hinge 14 deforms without breaking so as to absorb the forces induced by the air-bag 3 as it deploys. The folds 32 serve to further limit any risk of the hinge 14 tearing.

Nevertheless, the dashboard 1, which comprises a limited number of elements made of distinct materials, turns out to be simple and inexpensive to make.

In other variants, the plastics material constituting the hinge 14 and the panel 13 is different from that described above.

Preferably, said material presents elongation prior to rupture of more than 500%.

In general, the trim 4 may be of a structure other than that described above.

The principles described above can be applied to making an element for masking an air-bag other than a dashboard. For example, they can be applied to a door panel.

1-10. (canceled)

11. An assembly for masking an air-bag for a motor vehicle, the assembly being of the type comprising:
outer trim presenting a line of weakness which defines:
a flap overlying the air-bag; and
a peripheral region surrounding the flap and serving, after the flap has moved, to define an opening for passing the air-bag during its deployment;
a first reinforcing member for reinforcing the peripheral region, the first reinforcing member comprising at least one wall for guiding the air-bag upstream from the opening and during deployment thereof;
a second reinforcing member for reinforcing the flap; and
a hinge connecting together the first reinforcing member and the second reinforcing member so as to allow the flap to tilt and so as to retain it after the masking assembly has been ruptured along the line of weakness;
wherein the second reinforcing member and the hinge are made by molding a plastics material, and wherein the hinge is overmolded on the first reinforcing member.

12. An assembly according to claim 11, wherein the plastics material of the second reinforcing member and of the hinge possesses elongation prior to rupture of more than 500%.

13. An assembly according to claim 11, wherein the first reinforcing member includes portions in relief for connecting the hinge.

14. An assembly according to claim 11, wherein the hinge includes a retaining lip surrounding an edge of the first reinforcing member.

15. An assembly according to claim 11, wherein the guide wall(s) extend(s) over at least two sides of the deployment direction of the air-bag so as to form a guide channel.

16. An assembly according to claim 15, wherein the guide channel extends over substantially the entire perimeter of the through opening for the air-bag.

17. An assembly according to claim 11, wherein the hinge includes at least one fold.

18. An assembly according to claim 11, constituting at least a dashboard for a motor vehicle.

19. A method of making a masking assembly according to claim 11, the method including a step of overmolding a plastics material onto the first reinforcing member to form the hinge and the second reinforcing member, and to connect them to the first reinforcing member.

20. A method according to claim 19, including a step of fastening the first reinforcing member and the second reinforcing member to the trim that has previously been prepared.
